(19) United States
(12) Patent Application Publication
(10) Pub. No.: US 2018/0283518 A1
(43) Pub. Date: Oct. 4, 2018

(54) Robot And Gear Device

(71) Applicant: Seiko Epson Corporation, Tokyo (JP)

(72) Inventor: Yuya KATAOKA, Chino (JP)

(21) Appl. No.: 15/937,197

(22) Filed: Mar. 27, 2018

(30) Foreign Application Priority Data
Mar. 30, 2017 (JP) 2017-067191

(51) Int. Cl. F16H 49/00; B25J 17/00; F16C 19/16

(52) U.S. Cl. CPC F16H 49/001; F16C 2361/61; F16C 19/163; B25J 17/00

(57) ABSTRACT

A gear device includes an internal gear, an external gear having flexibility configured to partially mesh with the internal gear and relatively rotate around a rotation axis with respect to the internal gear, and a wave generator configured to come into contact with an inner circumferential surface of the external gear and move a meshing position of the internal gear and the external gear in a circumferential direction around the rotation axis. The wave generator includes a cam having a noncircular outer circumferential surface and a bearing disposed between the inner circumferential surface of the external gear and the outer circumferential surface of the cam. The bearing is an angular ball bearing.

### BACKGROUND

### 1. Technical Field

The present invention relates to a robot and a gear device.

### 2. Related Art

For example, in a robot including a robot arm including at least one arm, in general, a driving force of a motor for driving a joint section of the robot arm is reduced by a reduction gear. As such a reduction gear, for example, a gear device such as a wave gear device described in JP-A-2015-209931 (Patent Literature 1) is known.

For example, the wave gear device described in Patent Literature 1 includes a ring-like rigid internal gear, a flexible external gear configured to mesh with the rigid internal gear, and a wave generator disposed on the inner side of the flexible external gear and configured to move a meshing region of the rigid internal gear and the flexible external gear in a circumferential direction. The wave generator includes a bent annular flexible bearing (a deep groove ball bearing) on the outer circumferential surface of a rigid body formed in a noncircular shape.

In the wave gear device described in Patent Literature 1, not only a radial load but also a thrust load occurs on a bearing of the wave generator. In the wave gear device described in Patent Literature 1, sufficient measures against the thrust load are not taken. Therefore, the life of the wave generator is reduced.

### SUMMARY

An advantage of some aspects of the invention is to provide a robot and a gear device that can achieve an extension of the life of the gear device.

The invention can be implemented as the following application examples or forms.

A robot according to an application example includes: a first member; a second member including an arm and provided to be capable of turning with respect to the first member; and a gear device configured to transmit a driving force from one side to the other side of the first member and the second member. The gear device include: an internal gear; an external gear having flexibility configured to partially mesh with the internal gear and relatively rotate around a rotation axis with respect to the internal gear; and a wave generator configured to come into contact with an inner circumferential surface of the external gear and move a meshing position of the internal gear and the external gear in a circumferential direction around the rotation axis. The wave generator includes: a cam having a noncircular outer circumferential surface; and a bearing disposed between the inner circumferential surface of the external gear and the outer circumferential surface of the cam. The bearing is an angular ball bearing.

With such a robot, since the bearing included in the wave generator is the angular ball bearing, the bearing can sufficiently cope with both of a radial load and a thrust load (an axial load). That is, even if the radial load and the thrust load (the axial load) are applied to the bearing, it is possible to smoothly perform relative rotation of the external gear and the cam via the bearing. Therefore, it is possible to achieve an extension of the life of the bearing and an extension of the life of the gear device.

A robot according to another application example includes: a first member; a second member including an arm and provided to be capable of turning with respect to the first member; and a gear device configured to transmit a driving force from one side to the other side of the first member and the second member. The gear device include: an internal gear; an external gear having flexibility configured to partially mesh with the internal gear and relatively rotate around a rotation axis with respect to the internal gear; and a wave generator configured to come into contact with an inner circumferential surface of the external gear and move a meshing position of the internal gear and the external gear in a circumferential direction around the rotation axis. The wave generator includes: a cam having a noncircular outer circumferential surface; and a bearing disposed between the inner circumferential surface of the external gear and the outer circumferential surface of the cam. The bearing includes: an inner ring; an outer ring; and a plurality of balls disposed between the inner ring and the outer ring. The outer ring includes: an outer-ring-side raceway surface with which the plurality of balls are in contact; and a pair of outer-ring-side shoulder sections provided on both sides of the outer-ring-side raceway surface in a cross sectional view including the rotation axis, distances between the pair of outer-ring-side shoulder sections and the rotation axis being different from each other.

With such a robot, since the bearing included in the wave generator includes the pair of outer-ring-side shoulder sections having the different distances to the rotation axis each other, the bearing can sufficiently cope with both of a radial load and a thrust load (an axial load). That is, even if the radial load and the thrust load (the axial load) are applied to the bearing, it is possible to smoothly perform relative rotation of the external gear and the cam via the bearing. Therefore, it is possible to achieve an extension of the life of the bearing and an extension of the life of the gear device.

In the robot according to the application example, it is preferable that the external gear includes: a tubular body section, at one end portion of which external teeth are provided, the tubular body section centering on the rotation axis; and a connecting section connected to an end portion on an opposite side of the external teeth of the body section, the gear device is a reduction gear, an input shaft of which is connected to the cam, and a load acting point of the bearing is present further on the connecting section side than a center of the bearing.

With this configuration, when the gear device is used as the reduction gear, the bearing can sufficiently cope with a thrust load (an axial load). Note that, when the input shaft is connected to the internal gear or the external gear to use the gear device as a speed increasing gear, the load acting point of the bearing only has to be set further on an opposite side of the connecting section than the center of the bearing.

In the robot according to the application example, it is preferable that an outer circumferential surface of the outer ring inclines from one side toward the other side along the rotation axis.

With this configuration, it is possible to maintain the distances between the pair of outer-ring-side shoulder sections and the rotation axis in a desired relation on a major axis of the wave generator. Therefore, the bearing can sufficiently and more accurately cope with the thrust load (the axial load).

In the robot according to the application example, it is preferable that the inner ring includes: an inner-ring-side raceway surface with which the plurality of balls are in contact; and a pair of inner-ring-side shoulder sections having different heights each other provided on both sides of the inner-ring-side raceway surface in a cross sectional view including the rotation axis.

With this configuration, the bearing can sufficiently cope with the thrust load (the axial load) while reducing frictional resistance of the balls against the inner ring.

A gear device according to an application example includes: an internal gear; an external gear having flexibility configured to partially mesh with the internal gear and relatively rotate around a rotation axis with respect to the internal gear; and a wave generator configured to come into contact with an inner circumferential surface of the external gear and move a meshing position of the internal gear and the external gear in a circumferential direction around the rotation axis. The wave generator includes: a cam having a noncircular outer circumferential surface; and a bearing disposed between the inner circumferential surface of the external gear and the outer circumferential surface of the cam. The bearing is an angular ball bearing.

With such a gear device, since the bearing included in the wave generator is the angular ball bearing, the bearing can sufficiently cope with both of a radial load and a thrust load (an axial load). That is, it is possible to achieve an extension of the life of the bearing and an extension of the life of the gear device.

A gear device according to an application example includes: an internal gear; an external gear having flexibility configured to partially mesh with the internal gear and relatively rotate around a rotation axis with respect to the internal gear; and a wave generator configured to come into contact with an inner circumferential surface of the external gear and move a meshing position of the internal gear and the external gear in a circumferential direction around the rotation axis. The wave generator includes: a cam having a noncircular outer circumferential surface; and a bearing disposed between the inner circumferential surface of the external gear and the outer circumferential surface of the cam. The bearing includes: an inner ring; an outer ring; and a plurality of balls disposed between the inner ring and the outer ring. The outer ring includes: an outer-ring-side raceway surface with which the plurality of balls are in contact; and a pair of outer-ring-side shoulder sections provided on both sides of the outer-ring-side raceway surface in a cross sectional view including the rotation axis, distances between the pair of outer-ring-side shoulder sections and the rotation axis being different from each other.

With such a gear device, since the bearing included in the wave generator includes the pair of outer-ring-side shoulder sections having the different distances to the rotation axis each other, the bearing can sufficiently cope with both of a radial load and a thrust load (an axial load). Therefore, it is possible to achieve an extension of the life of the bearing and an extension of the life of the gear device.

### BRIEF DESCRIPTION OF THE DRAWINGS

The invention will be described with reference to the accompanying drawings, wherein like numbers reference like elements.

FIG. 1 is a diagram showing a schematic configuration of an embodiment of a robot according to the invention.

FIG. 2 is an exploded perspective view showing a gear device according to a first embodiment of the invention.

FIG. 3 is a longitudinal sectional view of the gear device shown in FIG. 2.

FIG. 4 is a front view of the gear device shown in FIG. 2.

FIG. 5 is a partially enlarged longitudinal sectional view of a bearing (in a natural state) of a wave generator included in the gear device shown in FIG. 2.

FIG. 6 is a partially enlarged longitudinal sectional view (a cross section taken along a major axis La in FIG. 4) of the wave generator included in the gear device shown in FIG. 2.

FIG. 7 is a partially enlarged longitudinal sectional view (a cross section taken along a minor axis Lb in FIG. 4) of the wave generator included in the gear device shown in FIG. 2.

FIG. 8 is a partially enlarged longitudinal sectional view showing a bearing (in a natural state) included in a gear device according to a second embodiment of the invention.

FIG. 9 is a partially enlarged longitudinal sectional view showing a bearing (in a natural state) included in a gear device according to a third embodiment of the invention.

FIG. 10 is a partially enlarged longitudinal sectional view showing a bearing (in a natural state) included in a gear device according to a fourth embodiment of the invention.

FIG. 11 is a longitudinal sectional view showing a gear device according to a fifth embodiment of the invention.

### DESCRIPTION OF EXEMPLARY EMBODIMENTS

A robot and a gear device according to the invention are explained in detail below with reference to preferred embodiments.

### 1. Robot

First, an embodiment of the robot according to the invention is explained.

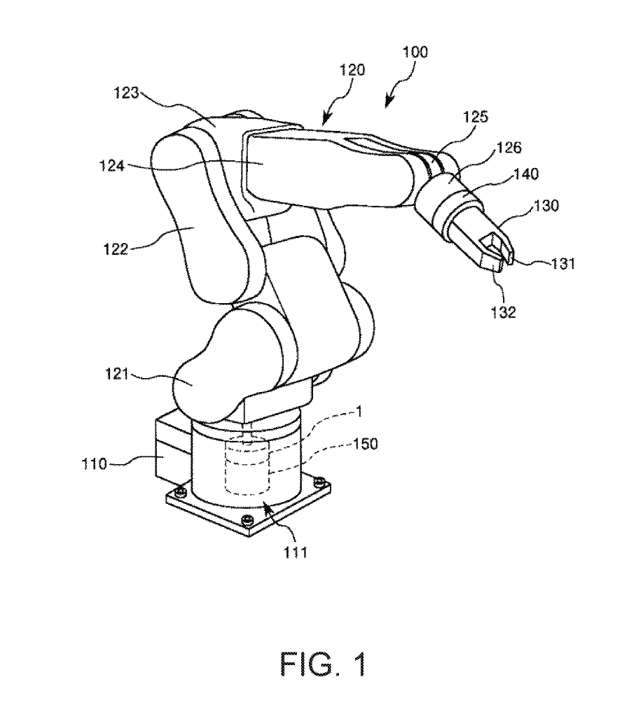

FIG. 1 is a diagram showing a schematic configuration of the embodiment of the robot according to the invention.

A robot 100 shown in FIG. 1 can perform work such as supply, removal, conveyance, and assembly of a precision instrument and components (objects) configuring the precision instrument.

The robot 100 is a six-axis vertical articulated robot and includes a base 111, a robot arm 120 connected to the base 111, and a force detector 140 and a hand 130 provided at the distal end portion of the robot arm 120. The robot 100 includes a control device 110 that controls a plurality of driving sources (including motors 150 and gear devices 1) that generate power for driving the robot arm 120.

The base 111 is a portion for attaching the robot 100 to any setting place. Note that a setting place of the base 111 is not particularly limited. Examples of the setting place include a floor, a wall, a ceiling, and a movable truck.

The robot arm 120 includes a first arm 121 (an arm), a second arm 122 (an arm), a third arm 123 (an arm), a fourth arm 124 (an arm), a fifth arm 125 (an arm), and a sixth arm 126 (an arm), which are coupled in this order from the proximal end side toward the distal end side of the robot arm 120. The first arm 121 is connected to the base 111. The hand 130 (an end effector), which grips various components and the like, is detachably attached to the distal end of the sixth arm 126. The hand 130 includes two fingers 131 and 132 and can grip various components and the like with the fingers 131 and 132.

A driving source including the motor 150 such as a servomotor, which drives the first arm 121, and the gear device (a reduction gear) is provided in the base 111. Although not shown in the figure, a plurality of driving sources including motors and reduction gears are respectively provided in the arms 121 to 126. The driving sources are controlled by the control device 110.

In such a robot 100, the gear device 1 transmits a driving force from one side to the other side of the base 111 (a first member) and the first arm 121 (a second member). More specifically, the gear device 1 transmits a driving force for turning the first arm 121 with respect to the base 111 from the base 111 side to the first arm 121 side. The gear device 1 functions as a reduction gear, whereby it is possible to reduce the driving force and turn the first arm 121 with respect to the base 111. Note that “turning” includes moving in both directions including one direction and the opposite direction of the one direction with respect to a certain center point and rotating with respect to the certain center point.

In this way, the robot 100 includes the base 111, which is the “first member”, the first arm 121, which is the “second member”, provided to be capable of turning with respect to the base 111, and the gear device 1 that transmits a driving force from one side to the other side of the base 111 (the first member) and the first arm 121 (the second member). Note that any number of arms sequentially selected from the first arm 121 side among the second to sixth arms 122 to 126 may be grasped as the “second member”. That is, a structure including the first arm 121 and the any number of arms sequentially selected from the first arm 121 side among the second to sixth arms 122 to 126 is considered to be the “second member”. For example, a structure including the first and second arms 121 and 122 is considered to be the “second member” or the entire robot arm 120 is considered to be the “second member”. The “second member” may include the hand 130. That is, a structure including the robot arm 120 and the hand 130 is considered to be the “second member”.

The robot 100 explained above includes the gear device 1 having a long life explained below. The gear device 1 is explained below as an example of the gear device according to the invention.

### 2. Gear Device

### First Embodiment

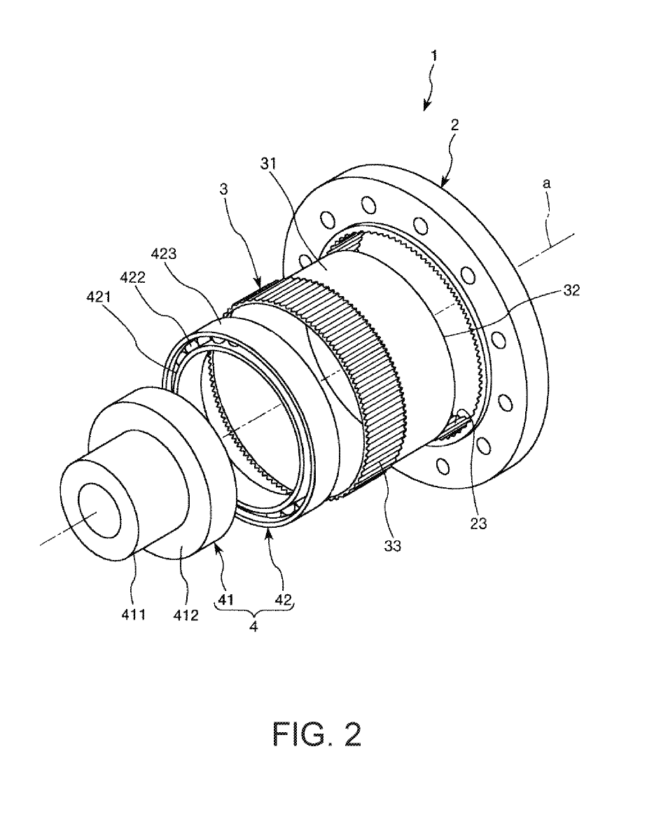

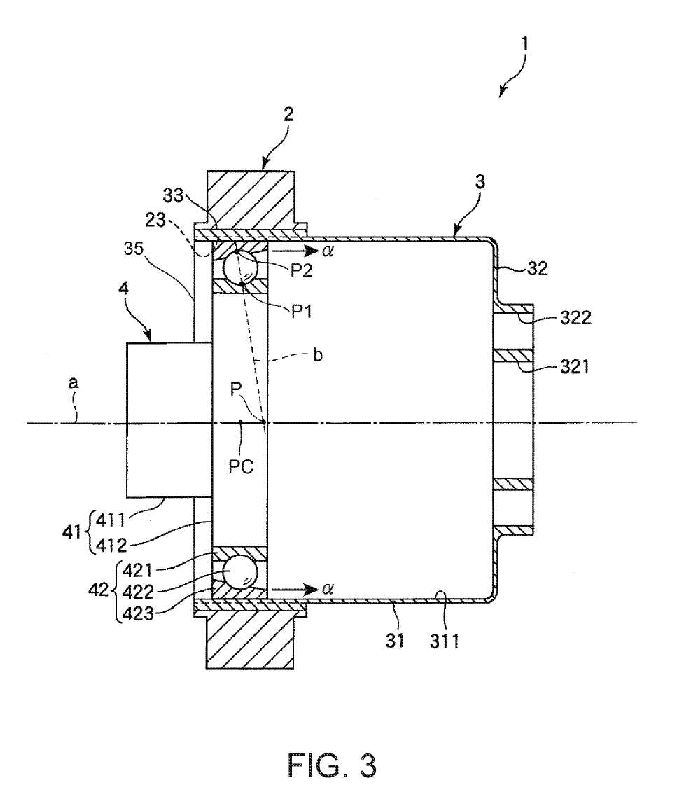

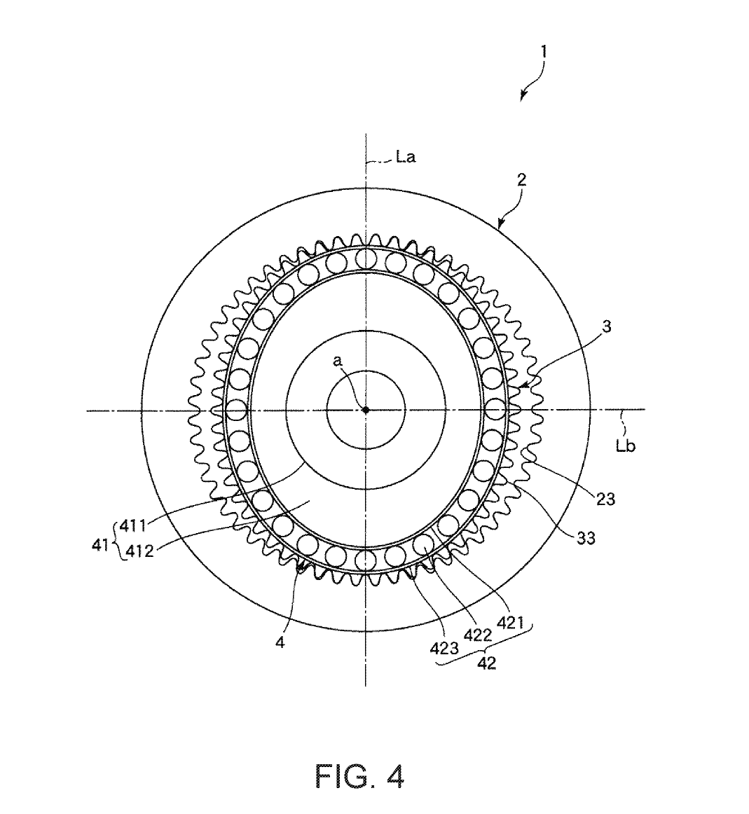

FIG. 2 is an exploded perspective view showing a gear device according to a first embodiment. FIG. 3 is a longitudinal sectional view of the gear device shown in FIG. 2. FIG. 4 is a front view of the gear device shown in FIG. 2. Note that, in the figures, for convenience of explanation, dimensions of sections are exaggerated and shown as appropriate according to necessity. Dimension ratios among the sections do not always coincide with actual dimension ratios.

The gear device 1 shown in FIGS. 2 to 4 is a wave gear device and is used as, for example, a reduction gear. The gear device 1 includes a rigid gear 2, which is an internal gear, a flexible gear 3, which is a cup-type external gear, disposed on the inner side of the rigid gear 2, and a wave generator 4 disposed on the inner side of the flexible gear 3. Although not shown in the figure, in sections (a sliding section and a contact section) of the gear device 1, a lubricant such as grease is disposed as appropriate according to necessity.

In the gear device 1, across section of the flexible gear 3 includes a portion deformed in an elliptical shape or an oval shape by the wave generator 4. The flexible gear 3 is in mesh with the rigid gear 2 at both end portions (an upper portion and a lower portion in FIGS. 3 and 4) on a major axis side of the portion. The numbers of teeth of the rigid gear 2 and the flexible gear 3 are different from each other.

In such a gear device 1, for example, when a driving force (e.g., a driving force of the motor 150 explained above) is input to the wave generator 4, the rigid gear 2 and the flexible gear 3 relatively rotate around an axis “a” because of the difference of the numbers of teeth while a meshing position of the rigid gear 2 and the flexible gear 3 moves in a circumferential direction. Consequently, it is possible to reduce the driving force input to the wave generator 4 from the driving force and output the driving force from the flexible gear 3. That is, it is possible to realize the reduction gear including the wave generator 4 set on an input shaft side and the flexible gear 3 set on an output shaft side.

The configuration of the gear device 1 is briefly explained below.

As shown in FIGS. 2 to 4, the rigid gear 2 is a gear configured by a rigid body that substantially does not bend in a radial direction and is a ring-like internal gear including internal teeth 23. In this embodiment, the rigid gear 2 is a spur gear. That is, the internal teeth 23 have teeth streaks parallel to the axis “a”. Note that the teeth streaks of the internal teeth 23 may incline with respect to the axis “a”. That is, the rigid gear 2 may be a bevel gear or a double helical gear.

The flexible gear 3 is inserted through the inner side of the rigid gear 2. The flexible gear 3 is a gear having flexibility deflectively deformable in the radial direction and is an external gear including external teeth 33 (teeth) that mesh with the internal teeth 23 of the rigid gear 2. The number of teeth of the flexible gear 3 is smaller than the number of teeth of the rigid gear 2. Since the numbers of teeth of the flexible gear 3 and the rigid gear 2 are different from each other, it is possible to realize the reduction gear.

In this embodiment, the flexible gear 3 is formed in a cup shape including an opening 35 at the left end in the axis “a” direction in FIG. 3. The external teeth 33 are formed on the outer circumferential surface of the flexible gear 3. The flexible gear 3 includes a tubular (more specifically, cylindrical) body section 31 (tube section) around the axis “a” and a bottom section 32 (a connecting section) connected to (formed on) one end portion side in the axis “a” direction of the body section 31 (the right side in the axis “a” direction in FIG. 3).

As shown in FIG. 3, in the bottom section 32, a hole 321 piercing through the bottom section 32 along the axis “a” and a plurality of holes 322 piercing through the bottom section 32 around the hole 321 are formed. A shaft body (not shown in FIG. 3) on an output side can be inserted through the hole 321. The holes 322 can be used as screw holes through which screws for fixing the shaft body (not shown in FIG. 3) on the output side to the bottom section 32 are inserted. Note that these holes only have to be provided as appropriate and can be omitted.

As shown in FIGS. 3 and 4, the wave generator 4 is disposed on the inner side of the flexible gear 3 and is capable of rotating around the axis “a”. The wave generator 4 deforms the cross section of the body section 31 of the flexible gear 3 into an elliptical shape or an oval shape having a major axis La and a minor axis Lb and meshes the external teeth 33 with the internal teeth 23 of the rigid gear 2. The flexible gear 3 and the rigid gear 2 are meshed on the inside and the outside each other to be capable of rotating around the same axis “a”.

In this embodiment, the wave generator 4 includes a cam 41 and a bearing 42 attached to the outer circumference of the cam 41. The cam 41 includes a shaft section 411 that rotates around the axis “a” and a cam section 412 that projects from one end portion of the shaft section 411 to the outer side. When viewed from a direction extending along the axis “a”, the outer circumferential surface of the cam section 412 is formed in an elliptical shape or an oval shape having a major axis in the up-down direction in FIGS. 3 and 4. The bearing 42 includes a flexible inner ring 421 and a flexible outer ring 423 and a plurality of balls 422 disposed between the inner ring 421 and the outer ring 423. The inner ring 421 is fit in the outer circumferential surface of the cam section 412 of the cam 41 and is elastically deformed in an elliptical shape or an oval shape along the outer circumferential surface of the cam section 412. According to the elastic deformation of the inner ring 421, the outer ring 423 is also elastically deformed into an elliptical shape or an oval shape. The outer circumferential surface of the outer ring 423 is in contact with an inner circumferential surface 311 of the body section 31. The outer circumferential surface of the inner ring 421 and the inner circumferential surface of the outer ring 423 are respectively formed as raceway surfaces for rolling the plurality of balls 422 while guiding the plurality of balls 422 along the circumferential direction. Although not shown in FIGS. 3 and 4, the plurality of balls 422 are held by a holder to keep an interval thereof in the circumferential direction constant.

In particular, the bearing 42 included in the wave generator 4 is an angular ball bearing. Consequently, even if both loads of a radial load (a load in a direction orthogonal to the axis “a”) and a thrust load (a load in a direction parallel to the axis “a”) are applied to the bearing 42, it is possible to smoothly perform relative rotation of the flexible gear 3 and the cam section 412 via the bearing 42. Note that the bearing 42 is explained in detail below.

In such a wave generator 4, the direction of the cam section 412 changes according to the rotation of the cam 41 around the axis “a”. The outer ring 423 is also deformed according to the change of the direction of the cam section 412. The wave generator 4 moves the meshing position of the rigid gear 2 and the flexible gear 3 in the circumferential direction. Note that, at this time, since the inner ring 421 is fixedly set on the outer circumferential surface of the cam section 412, a deformed state does not change.

The configuration of the gear device 1 is briefly explained above. In such a gear device 1, as explained above, for example, when a driving force (e.g., a driving force of the motor 150) is input to the wave generator 4, the rigid gear 2 and the flexible gear 3 relatively rotate around the axis “a” because of the difference of the numbers of teeth while the meshing position thereof moves in the circumferential direction. At that time, the body section 31 of the flexible gear 3 is repeatedly deformed in the radial direction thereof. According to such deformation, not only a radial load (a load in a direction perpendicular to the axis “a”) but also a thrust load (a load in the direction parallel to the axis “a”) is applied to the bearing 42. When the wave generator 4 side is set as an input side, the rigid gear 2 side or the flexible gear 3 side is set as an output side, and the gear device 1 is used as a reduction gear, as indicated by an arrow a in FIG. 3, the thrust load acts on the bearing 42 such that the outer ring 423 of the bearing 42 is pulled toward the bottom section 32 side of the flexible gear 3. The angular ball bearing is used as the bearing 42 in order to cope with such a thrust load. The bearing 42 is explained in detail below.

### Detailed Explanation of the Bearing

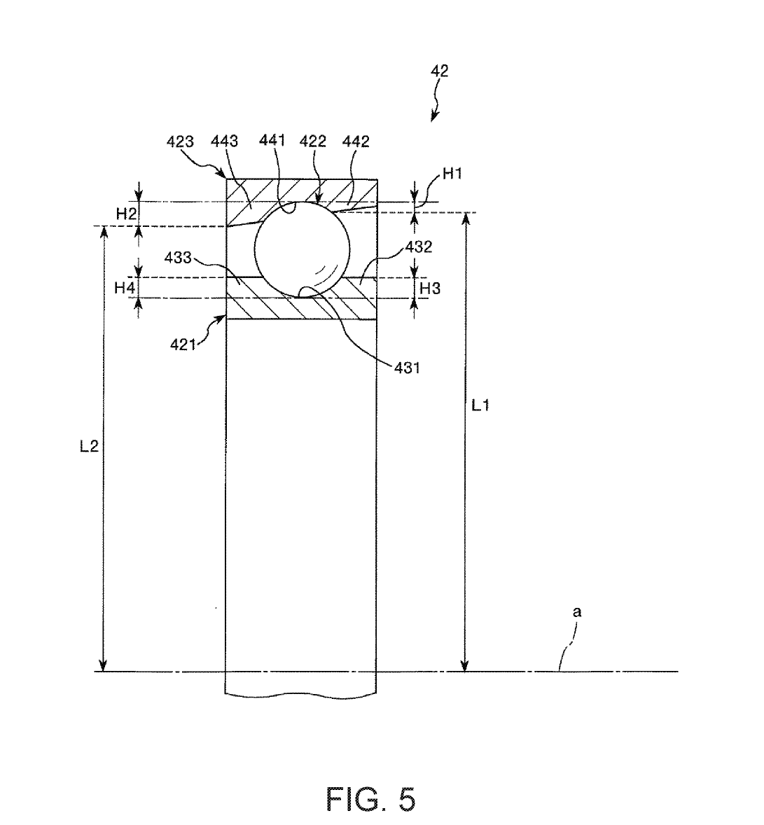

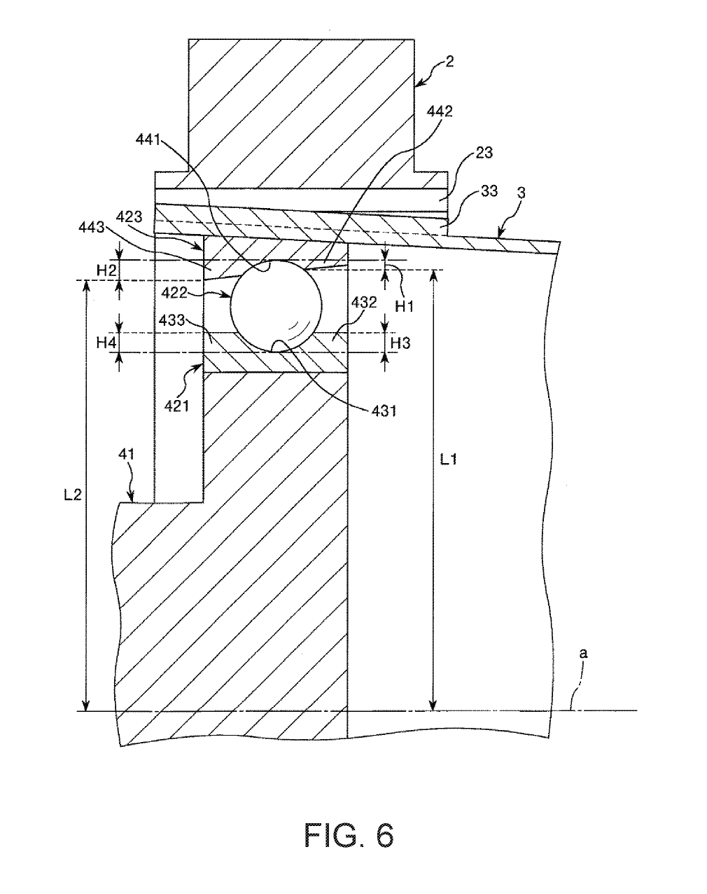

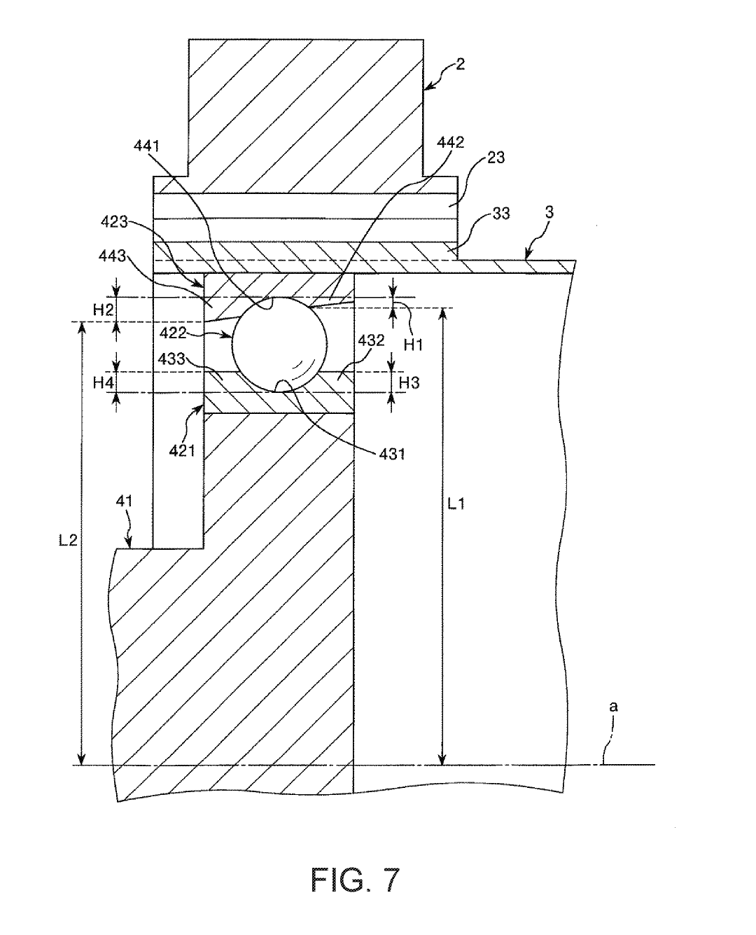

FIG. 5 is a partially enlarged longitudinal sectional view of the bearing (in a natural state) of the wave generator included in the gear device shown in FIG. 2. FIG. 6 is a partially enlarged longitudinal sectional view (a cross section along the major axis La in FIG. 4) of the wave generator included in the gear device shown in FIG. 2. FIG. 7 is a partially enlarged longitudinal sectional view (a cross section along the minor axis Lb in FIG. 4) of the wave generator included in the gear device shown in FIG. 2.

As shown in FIG. 5, the bearing 42 includes the flexible inner ring 421 and the flexible outer ring 423 and the plurality of balls 422 disposed in a row along the circumferential direction between the inner ring 421 and the outer ring 423. Note that FIG. 5 shows a natural state of the bearing 42 (a state in which the bearing 42 is detached from the gear device 1 and an external force is not applied to the bearing 42).

A raceway surface 431 (an inner-ring-side raceway surface) for rolling the plurality of balls 422 while guiding the plurality of balls 422 along the circumferential direction is provided on the outer circumferential surface of the inner ring 421. The raceway surface 431 is a concave shape extending along the circumferential direction of the inner ring 421, a cross section of the concave shape being formed in an arc having a radius slightly larger than the radius of the balls 422. Since such a raceway surface 431 is provided, on the outer circumferential surface of the inner ring 421, a pair of shoulder sections 432 and 433 (inner-ring-side shoulder sections) are provided on both sides of the raceway surface 431. The pair of shoulder sections 432 and 433 functions as a restricting section that restricts the balls 422 from moving in the direction along the axis “a” with respect to the inner ring 421 with the thrust load explained above. Note that the inner ring 421 does not have to have flexibility. In this case, the inner ring 421 only has to be formed in a shape corresponding to the shape of the outer circumferential surface of the cam section 412 in the natural state. The inner ring 421 may be configured integrally with the cam section 412.

In this embodiment, heights H3 and H4 of the pair of shoulder sections 432 and 433 are equal to each other. Note that, for example, as in a third embodiment explained below, the heights of the pair of shoulder sections 432 and 433 may be different from each other.

The heights H3 and H4 of the pair of shoulder sections 432 and 433 are respectively not particularly limited. However, the heights H3 and H4 are desirably equal to or larger than 1/20 and equal to or smaller than ½ and more desirably equal to or larger than 1/15 and equal to or smaller than ⅓ with respect to the radius of the balls 422.

On the inner circumferential surface of the outer ring 423, a raceway surface 441 (an outer-ring-side raceway surface) for rolling the plurality of balls 422 while guiding the plurality of balls 422 along the circumferential direction is provided. The raceway surface 441 is a concave shape extending along the circumferential direction of the outer ring 423, a cross section of the concave shape being formed in an arc having a radius slightly larger than the radius of the balls 422. Since such a raceway surface 441 is provided, on the inner circumferential surface of the outer ring 423, a pair of shoulder sections 442 and 443 (outer-ring-side shoulder sections) is provided on both sides of the raceway surface 441. The pair of shoulder sections 442 and 443 is respectively considered to be convex shapes that extend along the circumferential direction of the outer ring 423 and project toward the inner ring 421 side. The pair of shoulder sections 442 and 443 functions as a restricting section that restricts the balls 422 from moving in the direction along the axis “a” with respect to the outer ring 423 with the thrust load explained above.

In this embodiment, height H2 of the shoulder section 443 on the left side in FIG. 5 is larger than height H1 of the shoulder section 442 on the right side in FIG. 5. That is, a distance L2 between the shoulder section 443 and the axis “a” is smaller than a distance L1 between the shoulder section 442 and the axis “a”. By differentiating the heights of the pair of shoulder sections 442 and 443 from each other in this way, it is possible to sufficiently cope with the thrust load explained above while securing necessary flexibility of the outer ring 423.

As shown in FIG. 5, the top surfaces of the pair of shoulder sections 442 and 443 incline with respect to the axis “a” to extend along the same line when viewed in a cross section including the axis “a”. The top surface of the shoulder section 442 inclines with respect to the axis “a” to be higher toward the shoulder section 443 side. The top surface of the shoulder section 443 inclines with respect to the axis “a” to be lower toward the shoulder section 442 side. Note that inclining directions of the top surfaces of the shoulder sections 442 and 443 are not respectively limited to directions shown in FIG. 5. The top surface of at least one of the shoulder sections 442 and 443 may be parallel to the axis “a” as in a fourth embodiment explained below.

The height H1 of the shoulder section 442 is desirably smaller than the height H3 of the shoulder section 432 or the height H4 of the shoulder section 433. Consequently, it is possible to easily secure the necessary flexibility of the outer ring 423. The height H2 of the shoulder section 443 may be higher or lower than the height H3 of the shoulder section 432 or the height H4 of the shoulder section 433 but is desirably equal to or larger than 0.5 times and equal to or smaller than 1.5 times as large as the height H3 of the shoulder section 432 or the height H4 of the shoulder section 433. Consequently, it is possible to, while easily securing the necessary flexibility of the outer ring 423, easily realize the shoulder section 443 that can withstand a thrust load acting on the bearing 42. Note that the width (the length in the direction along the axis “a”) of the shoulder sections 442 and 443 is not particularly limited and can be set to the width of shoulder sections of an outer ring included in a publicly-known bearing.

Even in a state in which the bearing 42 having the configuration explained above is incorporated in the gear device 1 as shown in FIGS. 6 and 7, the distance L2 between the shoulder section 443 and the axis “a” is smaller than the distance L1 between the shoulder 442 and the axis “a”.

In the cross section shown in FIG. 6, that is, a cross section taken along the axis “a” of a portion of the flexible gear 3 expanded in a direction along the major axis La by the cam section 412, the outer ring 423 receives, from the flexible gear 3 side, a load with which a portion on the right side in FIG. 6 of the outer ring 423 is displaced in a direction approaching the axis “a”. Even in such a portion that receives the load, since the distance L2 is smaller than the distance L1, it is possible to sufficiently restrict the balls 422 from moving in the direction along the axis “a” with respect to the inner ring 421 with the thrust load explained above. Note that, in the portion, the distance L1 and the distance L2 does not always have to be in a relation of the distance L2<the distance L1. Even in this case, it is possible to cope with the thrust load to a certain degree as explained below.

In the cross section shown in FIG. 7, that is, a cross section taken along the axis “a” of a portion of the flexible gear 3 reduced in a direction along the minor axis Lb by the cam section 412, the outer ring 423 rarely receives the load explained with reference to FIG. 6 above or receives, from the flexible gear 3 side, a load with which a portion on the left side in FIG. 7 of the outer ring 423 is displaced in the direction approaching the axis “a”. In such a portion that receives the load, the distance L2 is smaller than the distance L1 in the same degree as the state shown in FIG. 5 (i.e., the natural state in which the cam section 42 is not incorporated in the gear device 1) or is much smaller. It is possible to sufficiently restrict the balls 422 from moving in the direction along the axis “a” with respect to the inner ring 421 with the thrust load explained above.

In such a bearing 42, as shown in FIG. 3, a straight line “b” connecting a contact point P1 of the ball 422 and the inner ring 421 and a contact point P2 of the ball 422 and the outer ring 423 inclines with respect to the radial direction (the direction perpendicular to the axis “a”). An angle of this inclination (a contact angle) is not particularly limited but is desirably equal to or larger than 0.5° and equal to or smaller than 40°. A point where the straight line “b” crosses the axis “a” when viewed in the cross section including the axis “a” is referred to as load acting point P. In this embodiment, the load acting point P is located on the bottom section 32 side with respect to a center PC in the axis “a” direction of the bearing 42 (see FIG. 3).

As explained above, the gear device 1 includes the rigid gear 2, which is the internal gear, the flexible gear 3, which is the external gear, having flexibility that partially meshes with the rigid gear 2 and relatively rotates around the axis “a” (the rotation axis) with respect to the rigid gear 2, and the wave generator 4 that is in contact with the inner circumferential surface of the rigid gear 2 and moves the meshing position of the rigid gear 2 and the flexible gear 3 in the circumferential direction around the axis “a”. The wave generator 4 includes the cam 41 including the noncircular outer circumferential surface and the bearing 42 disposed between the inner circumferential surface of the rigid gear 2 and the outer circumferential surface of the cam 41 in contact with the inner circumferential surface and the outer circumferential surface.

The bearing 42 is the angular ball bearing. More specifically, the bearing 42 includes the inner ring 421, the outer ring 423, and the plurality of balls 422 disposed between the inner ring 421 and the outer ring 423. The outer ring 423 includes the raceway surface 441, which is the outer-ring-side raceway surface with which the plurality of balls 422 are in contact, and the shoulder sections 442 and 443, which are the pair of outer-ring-side shoulder sections, provided on both the sides of the raceway surface 441 in a cross sectional view including the axis “a” (the rotation axis), the distances L1 and L2 between the pair of shoulder sections 442 and 443 and the axis “a” being different from each other.

With such a gear device 1, the bearing 42 included in the wave generator 4 is the angular ball bearing. More specifically, the bearing 42 includes the pair of shoulder sections 442 and 443 having different distances L1 and L2 to the axis “a” each other. Therefore, the bearing 42 can sufficiently cope with both of the radial load and the thrust load (the axial load). That is, even if both of the radial load and the thrust load (the axial load) are applied to the bearing 42, it is possible to smoothly perform relative rotation of the flexible gear 3 and the cam 41 via the bearing 42. Therefore, it is possible to achieve an extension of the life of the bearing 42 and an extension of the life of the gear device 1.

In this embodiment, the flexible gear 3 (the external gear) includes the tubular body section 31, at one end portion of which the external teeth 33 are provided, the tubular body section 31 centering on the axis “a” (the rotation axis) and the bottom section 32, which is the connecting section, connected to the end portion on the opposite side of the external teeth 33 of the body section 31. The gear device 1 is the reduction gear, the input shaft of which is connected to the cam 41. The load acting point of the bearing 42 is present further on the bottom section 32 side than the center of the bearing 42. Consequently, when the gear device 1 is used as the reduction gear, the bearing 42 can sufficiently cope with the thrust load (the axial load). Note that, when the input shaft is connected to the rigid gear 2 or the flexible gear 3 to use the gear device 1 as a speed-increasing gear, the load acting point of the bearing 42 only has to be set further on the opposite side of the bottom section 32 than the center of the bearing 42.

### Second Embodiment

A second embodiment of the invention is explained.

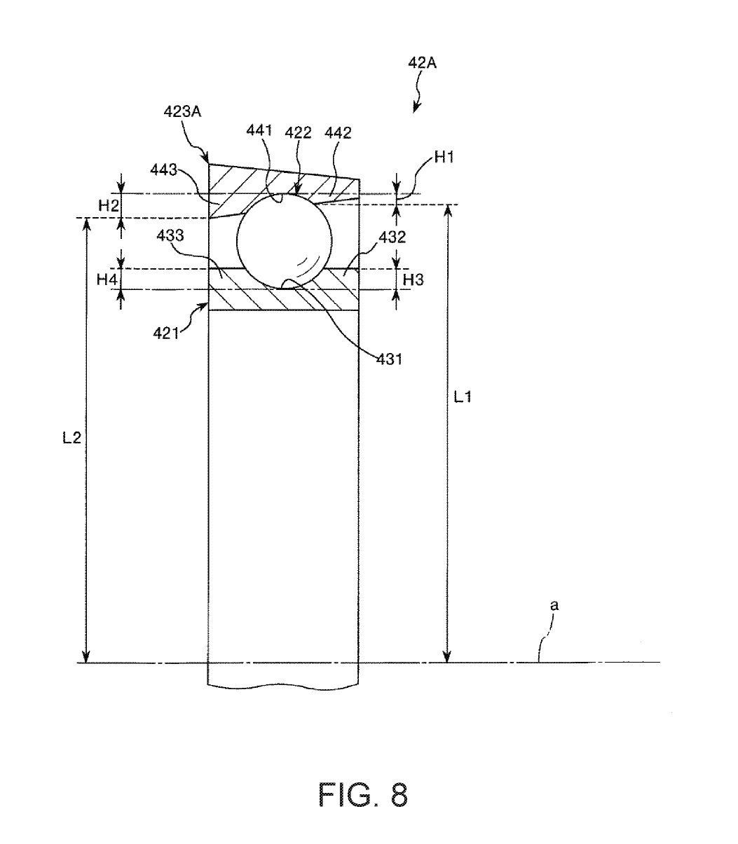

FIG. 8 is a partially enlarged longitudinal sectional view showing a bearing (in a natural state) included in a gear device according to the second embodiment of the invention.

This embodiment is the same as the first embodiment explained above except that the configuration of an outer ring of the bearing is different. Note that, in the following explanation, concerning this embodiment, differences from the first embodiment are mainly explanation. Explanation of similarities is omitted. In FIG. 8, the same components as the components in the first embodiment are denoted by the same reference numerals and signs.

A bearing 42A shown in FIG. 8 is, for example, a bearing used instead of the bearing 42 in the gear device 1 in the first embodiment explained above. The bearing 42A includes the flexible inner ring 421 and a flexible outer ring 423A and the plurality of balls 422 disposed between the inner ring 421 and the outer ring 423A. Note that FIG. 8 shows a natural state of the bearing 42A (a state in which the bearing 42A is detached from the gear device 1 and an external force is not applied to the bearing 42A).

As in the outer ring 423 in the first embodiment explained above, the raceway surface 441 and the pair of shoulder sections 442 and 443 (the outer-ring-side shoulder sections) are provided on the inner circumferential surface of the outer ring 423A. As explained above, the top surfaces of the pair of shoulder sections 442 and 443 incline with respect to the axis “a” to extend along the same line when viewed in the cross section including the axis “a”. On the other hand, the outer circumferential surface of the outer ring 423A inclines with respect to the axis “a” to the opposite side of the shoulder sections 442 and 443 (the outer-ring-side shoulder sections). Consequently, in a state in which the bearing 42A is incorporated in the gear device, it is easy to satisfy the relation of the distance L2<the distance L1 over the entire area in the circumferential direction. An inclination angle of the outer circumferential surface of the outer ring 423A with respect to the axis “a” is not particularly limited. The inclination angle is desirably, for example, larger than 0° and equal to or smaller than 10°.

In this way, the outer circumferential surface of the outer ring 423A inclines from one side to the other side along the axis “a” (the rotation axis). Consequently, it is possible to maintain the distances between the pair of shoulder sections 442 and 443 (the outer-ring-side shoulder sections) and the axis “a” in a desired relation on a major axis of the wave generator in which the bearing 42A is incorporated. Therefore, the bearing 42A can sufficiently and more accurately cope with the thrust load (the axial load).

According to the second embodiment explained above, as in the first embodiment, it is possible to achieve an extension of the life of the gear device.

### Third Embodiment

A third embodiment of the invention is explained.

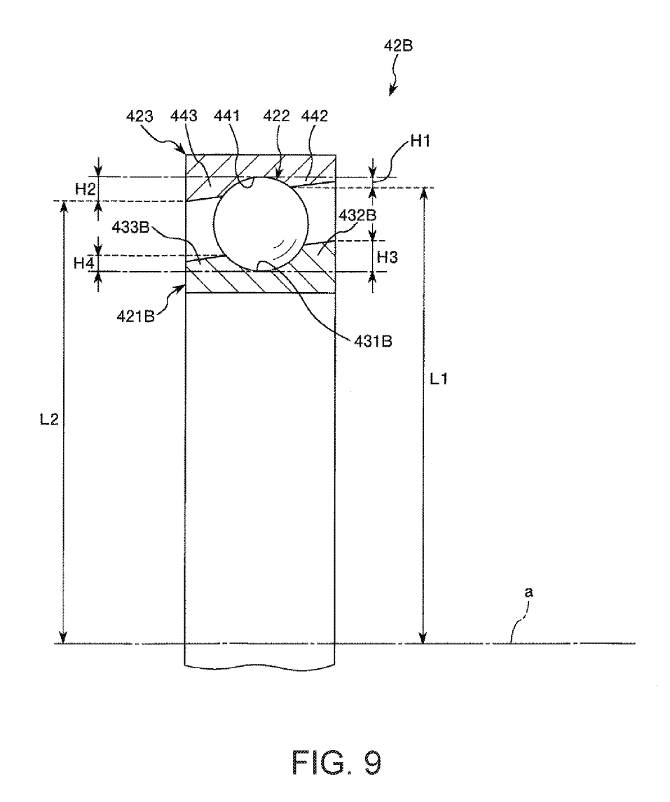

FIG. 9 is a partially enlarged longitudinal sectional view showing a bearing (in a natural state) included in a gear device according to the third embodiment of the invention.

This embodiment is the same as the first embodiment explained above except that the configuration of an inner ring of the bearing is different. Note that, in the following explanation, concerning this embodiment, differences from the embodiments explained above are mainly explained. Explanation of similarities is omitted. In FIG. 9, the same components as the components in the embodiments explained above are denoted by the same reference numerals and signs.

A bearing 42B shown in FIG. 9 is, for example, a bearing used instead of the bearing 42 in the gear device 1 in the first embodiment explained above. The bearing 42B includes a flexible inner ring 421B and the flexible outer ring 423 and the plurality of balls 422 disposed between the inner ring 421B and the outer ring 423. Note that FIG. 9 shows a natural state of the bearing 42B (a state in which the bearing 42B is detached from the gear device 1 and an external force is not applied to the gear 42B).

A raceway surface 431B (an inner-ring-side raceway surface) for rolling the plurality of balls 422 while guiding the plurality of balls 422 along the circumferential direction is provided on the outer circumferential surface of the inner ring 421B. Since the raceway surface 431B is provided, a pair of shoulder sections 432B and 433B (inner-ring-side shoulder sections) is provided on both sides of the raceway surface 431B on the outer circumferential surface of the inner ring 421B. The pair of shoulder sections 432B and 433B functions as a restricting section that restricts the balls 422 from moving in the direction along the axis “a” with respect to the inner ring 421B with the thrust load explained above.

In this embodiment, height H3 of the shoulder section 432B on the right side in FIG. 9 (the shoulder 442 side of the outer ring 423) is larger than height H4 of the shoulder section 433B on the left side in FIG. 9 (the shoulder section 443 side of the outer ring 423). By differentiating the heights of the pair of shoulder sections 432B and 433B from each other in this way, it is possible to improve the function of the restricting section explained above while reducing frictional resistance of the ball 422 against the inner ring 421B.

As shown in FIG. 9, the top surfaces of the pair of shoulder sections 432B and 433B incline with respect to the axis “a” to extend along the same line when viewed in a cross section including the axis “a”. The top surface of the shoulder section 433B inclines with respect to the axis “a” to be higher toward the shoulder section 432B side. The top surface of the shoulder section 432B inclines with respect to the axis “a” to be lower toward the shoulder section 433B side. Note that inclining directions of the top surfaces of the shoulder sections 432B and 433B are not respectively limited to directions shown in FIG. 9. The top surface of at least one of the shoulder sections 432B and 433B may be parallel to the axis “a”.

In this way, the inner ring 421B includes the raceway surface 431B, which is the inner-ring-side raceway surface, with which the plurality of balls 422 are in contact, and the shoulder sections 432B and 433B, which are the pair of inner-ring-side shoulder sections, provided on both the sides of the raceway surface 431B in a cross sectional view including the axis “a” (the rotation axis) and having the different heights each other. Consequently, the bearing 42B can sufficiently cope with the thrust load (the axial load) while reducing frictional resistance of the balls 422 against the inner ring 421B.

According to the third embodiment explained above, as in the first and second embodiments, it is possible to achieve an extension of the life of the gear device.

### Fourth Embodiment

A fourth embodiment of the invention is explained.

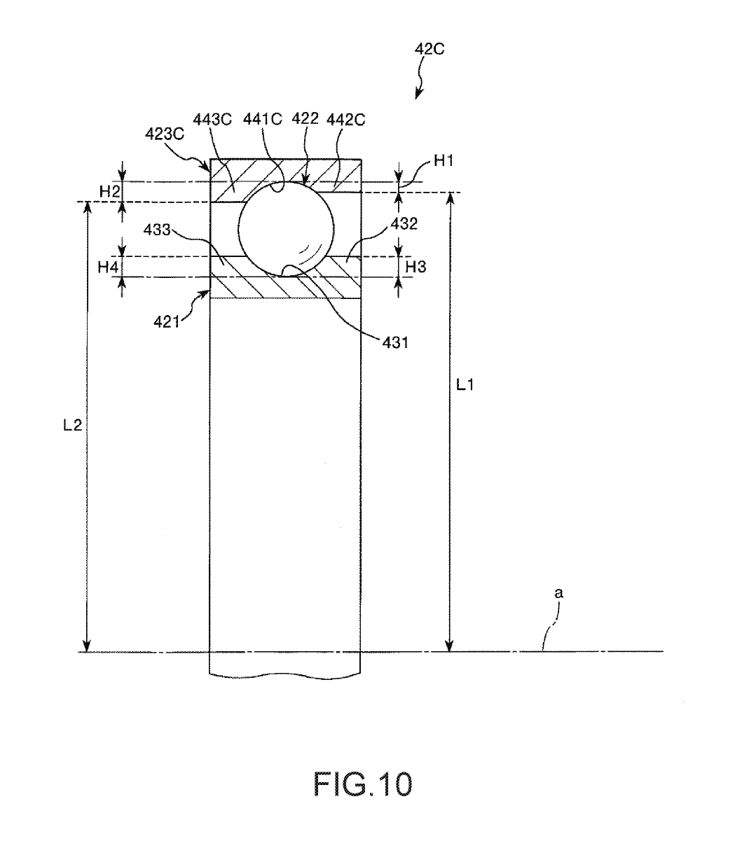

FIG. 10 is a partially enlarged longitudinal sectional view showing a bearing (in a natural state) included in a gear device according to the fourth embodiment of the invention.

This embodiment is the same as the first embodiment explained above except that the configuration of an outer ring of the bearing is different. Note that, in the following explanation, concerning this embodiment, differences from the embodiments explained above are mainly explanation. Explanation of similarities is omitted. In FIG. 10, the same components as the components in the embodiments explained above are denoted by the same reference numerals and signs.

A bearing 42C shown in FIG. 10 is, for example, a bearing used instead of the bearing 42 in the gear device 1 in the first embodiment explained above. The bearing 42C includes the flexible inner ring 421 and a flexible outer ring 423C and the plurality of balls 422 disposed between the inner ring 421 and the outer ring 423C. Note that FIG. 10 shows a natural state of the bearing 42C (a state in which the bearing 42C is detached from the gear device 1 and an external force is not applied to the gear 42C).

A raceway surface 441C (an outer-ring-side raceway surface) for rolling the plurality of balls 422 while guiding the plurality of balls 422 along the circumferential direction is provided on the inner circumferential surface of the outer ring 423C. Since the raceway surface 441C is provided, a pair of shoulder sections 442C and 443C (outer-ring-side shoulder sections) is provided on both sides of the raceway surface 441C on the inner circumferential surface of the outer ring 423C. The pair of shoulder sections 442C and 443C functions as a restricting section that restricts the balls 422 from moving in the direction along the axis “a” with respect to the outer ring 423C with the thrust load explained above.

Height H2 of the shoulder section 443C on the left side in FIG. 10 is larger than height H1 of the shoulder section 442C on the right side in FIG. 10. By differentiating the heights of the pair of shoulder sections 442C and 443C from each other in this way, it is possible to sufficiently cope with the thrust load explained above while securing necessary flexibility of the outer ring 423C.

As shown in FIG. 10, the top surfaces of the pair of shoulder sections 442C and 443C are parallel to the axis “a” when viewed in a cross section including the axis “a”.

According to the forth embodiment above, as in the embodiments explained above, it is possible to achieve an extension of the life of the gear device.

### Fifth Embodiment

A fifth embodiment of the invention is explained.

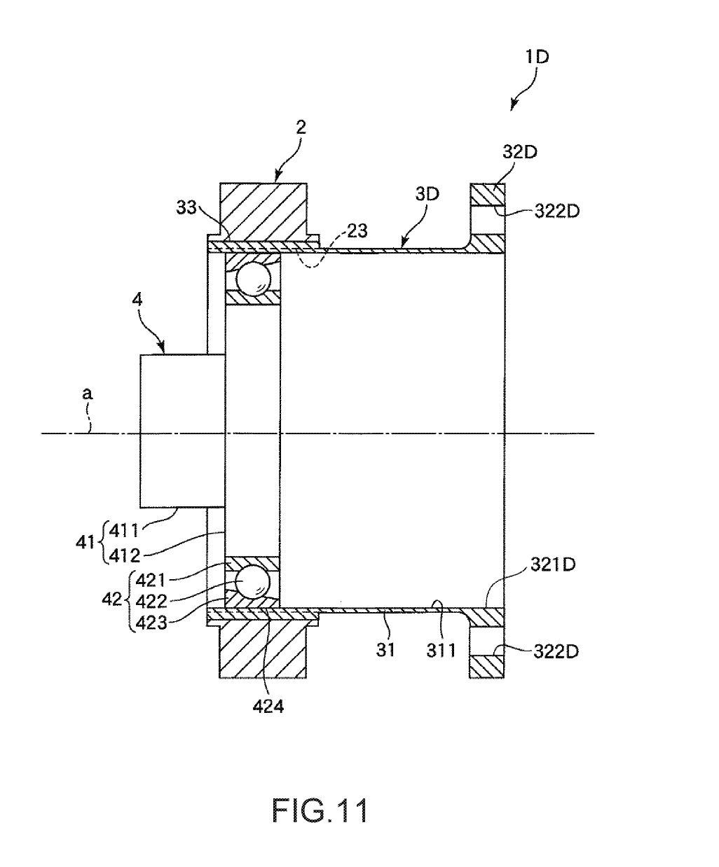

FIG. 11 is a longitudinal sectional view showing a gear device according to the fifth embodiment of the invention.

This embodiment is the same as the first embodiment explained above except that the configuration of a flexible gear is different. Note that, in the following explanation, concerning this embodiment, differences from the embodiments explained above are mainly explanation. Explanation of similarities is omitted. In FIG. 11, the same components as the components in the embodiments explained above are denoted by the same reference numerals and signs.

A gear device 1D shown in FIG. 11 includes a flexible gear 3D, which is a hat-type external gear, disposed on the inner side of the rigid gear 2. The flexible gear 3D includes a flange section 32D (a connecting section) connected to one end portion of the tubular body section 31 and projecting to the opposite side of the axis “a”. A plurality of holes 322D piercing through the flange section 32D along the axis “a” are formed in the flange section 32D. The holes 322D can be used as screw holes through which screws for fixing a shaft body on an output side to the flange section 32D are inserted. The shaft body on the output side can be inserted through an inner circumferential section 321D of the flange section 32D.

Like the gear device 1 in the first embodiment explained above, such a gear device 1D includes the bearing (or 42A, 42B, or 42C), which is the angular bearing. Consequently, even if both loads of a radial load (a load in the direction orthogonal to the axis “a”) and a thrust load (a load in the direction parallel to the axis “a”) are applied to the bearing 42, it is possible to smoothly perform relative rotation of the flexible gear 3D and the cam section 412 via the bearing 42.

According to the fifth embodiment explained above, as in the embodiments explained above, it is possible to achieve an extension of the life of the gear device 1D.

The robot, the flexible gear, and the gear device according to the invention are explained with reference to the embodiments shown in the figures. However, the invention is not limited to this. The components of the sections can be replaced with any components having the same functions. Any other components may be added to the invention. The embodiments may be combined as appropriate.

In the embodiments explained above, the base included in the robot is the “first member” and the first arm is the “second member”. The gear device that transmits the driving force from the first member to the second member is explained. However, the invention is not limited to this. The invention is also applicable to a robot in which an n-th (n is an integer equal to or larger than 1) arm is the “first member” and a (n+1)-th arm is the “second member”. The invention is also applicable to a gear device that transmits the driving force from one to the other of the n-th arm and the (n+1)-th arm. The invention is also applicable to a gear device that transmits the driving force from the second member to the first member.

In the embodiments, the six-axis vertical articulated robot is explained. However, the invention is not limited to this and is applicable to any robot that uses a gear device including a flexible gear. For example, the number of joints of the robot is optional. The invention is also applicable a horizontal articulated robot.

The invention is not limited to the wave gear device in the embodiments. The invention is applicable to various gear devices including a cup-like flexible gear.

The gear device according to the invention can be set in any apparatus (including a driving-force transmitting section) other than the robot.

The entire disclosure of Japanese Patent Application No. 2017-067191, filed Mar. 30, 2017 is expressly incorporated by reference herein.

What is claimed is:

1. A robot comprising:
a first member;
a second member including an arm and provided to be capable of turning with respect to the first member; and
a gear device configured to transmit a driving force from one side to the other side of the first member and the second member, wherein
the gear device include:
an internal gear;
an external gear having flexibility configured to partially mesh with the internal gear and relatively rotate around a rotation axis with respect to the internal gear; and
a wave generator configured to come into contact with an inner circumferential surface of the external gear and move a meshing position of the internal gear and the external gear in a circumferential direction around the rotation axis,
the wave generator includes:
a cam having a noncircular outer circumferential surface; and
a bearing disposed between the inner circumferential surface of the external gear and the outer circumferential surface of the cam, and
the bearing is an angular ball bearing.

2. A robot comprising:
a first member;
a second member including an arm and provided to be capable of turning with respect to the first member; and
a gear device configured to transmit a driving force from one side to the other side of the first member and the second member, wherein
the gear device include:
an internal gear;
an external gear having flexibility configured to partially mesh with the internal gear and relatively rotate around a rotation axis with respect to the internal gear; and
a wave generator configured to come into contact with an inner circumferential surface of the external gear and move a meshing position of the internal gear and the external gear in a circumferential direction around the rotation axis,
the wave generator includes:
a cam having a noncircular outer circumferential surface; and
a bearing disposed between the inner circumferential surface of the external gear and the outer circumferential surface of the cam,
the bearing includes:
an inner ring;
an outer ring; and
a plurality of balls disposed between the inner ring and the outer ring, and
the outer ring includes:
an outer-ring-side raceway surface with which the plurality of balls are in contact; and
a pair of outer-ring-side shoulder sections provided on both sides of the outer-ring-side raceway surface in a cross sectional view including the rotation axis, distances between the pair of outer-ring-side shoulder sections and the rotation axis being different from each other.

3. The robot according to claim 2, wherein
the external gear includes:
a tubular body section, at one end portion of which external teeth are provided, the tubular body section centering on the rotation axis; and
a connecting section connected to an end portion on an opposite side of the external teeth of the body section,
the gear device is a reduction gear, an input shaft of which is connected to the cam, and
a load acting point of the bearing is present further on the connecting section side than a center of the bearing.

4. The robot according to claim 2, wherein an outer circumferential surface of the outer ring inclines from one side toward the other side along the rotation axis.

5. The robot according to claim 2, wherein the inner ring includes:
an inner-ring-side raceway surface with which the plurality of balls are in contact; and
a pair of inner-ring-side shoulder sections having different heights each other provided on both sides of the inner-ring-side raceway surface in a cross sectional view including the rotation axis.

6. A gear device comprising:
an internal gear;
an external gear having flexibility configured to partially mesh with the internal gear and relatively rotate around a rotation axis with respect to the internal gear; and
a wave generator configured to come into contact with an inner circumferential surface of the external gear and move a meshing position of the internal gear and the external gear in a circumferential direction around the rotation axis, wherein
the wave generator includes:
a cam having a noncircular outer circumferential surface; and
a bearing disposed between the inner circumferential surface of the external gear and the outer circumferential surface of the cam, and
the bearing is an angular ball bearing.

7. A gear device comprising:
an internal gear;
an external gear having flexibility configured to partially mesh with the internal gear and relatively rotate around a rotation axis with respect to the internal gear; and
a wave generator configured to come into contact with an inner circumferential surface of the external gear and move a meshing position of the internal gear and the external gear in a circumferential direction around the rotation axis, wherein
the wave generator includes:
a cam having a noncircular outer circumferential surface; and
a bearing disposed between the inner circumferential surface of the external gear and the outer circumferential surface of the cam,
the bearing includes:
an inner ring;
an outer ring; and
a plurality of balls disposed between the inner ring and the outer ring, and
the outer ring includes:
an outer-ring-side raceway surface with which the plurality of balls are in contact; and
a pair of outer-ring-side shoulder sections provided on both sides of the outer-ring-side raceway surface in a cross sectional view including the rotation axis, distances between the pair of outer-ring-side shoulder sections and the rotation axis being different from each other.
